(19) United States
(12) Patent Application Publication
(10) Pub. No.: US 2025/0211047 A1
(43) Pub. Date: Jun. 26, 2025

(54) ROTARY ELECTRIC MACHINE COIL AND ROTARY ELECTRIC MACHINE

(71) Applicant: HONDA MOTOR CO., LTD., Tokyo (JP)

(72) Inventors: Kentaro Fukui, Tokyo (JP); Kenta Toyomaki, Tokyo (JP)

(21) Appl. No.: 18/925,116

(22) Filed: Oct. 24, 2024

(30) Foreign Application Priority Data
Dec. 21, 2023 (JP) 2023-215733

(51) Int. Cl. H02K 3/24; H02K 1/16; H02K 3/32

(52) U.S. Cl. CPC H02K 3/24; H02K 1/16; H02K 3/32

(57) ABSTRACT

In a rotary electric machine coil, a cooling liquid flow groove is formed on one side surface. In a recess shape cross section of the cooling liquid flow groove, values a, b, x, R are set such that the following conditions (1), (2) are satisfied.

b/a≤T1 (1)

((b−a)R+ax)/2≥T2 (2)
a: a length of a virtual string that connects opening ends of a recess shape having the recess shape cross section to each other by a straight line
b: a length of an arc along an inner surface of the recess shape
x: a depth from the virtual string of the recess shape to the deepest portion of the arc
R: a radius of the arc
T1: a first predetermined value
T2: a second predetermined value

### CROSS-REFERENCE TO RELATED APPLICATION

Priority is claimed on Japanese Patent Application No. 2023-215733, filed on Dec. 21, 2023, the contents of which are incorporated herein by reference.

### BACKGROUND

### Field of the Invention

The present invention relates to a rotary electric machine coil and a rotary electric machine.

### Background

As a rotary electric machine such as an electric motor or an electricity generator, a rotary electric machine is known in which a rotor is arranged to be rotatable on an inside in a radial direction of a stator having an annular shape. The stator includes a stator core and a coil (rotary electric machine coil) that is wound around the stator core. In the stator core, for example, a back yoke having a cylindrical shape and a plurality of teeth portions that protrude inward in the radial direction from the back yoke are integrally formed. A slot is formed between the teeth portions that are adjacent to each other in a circumferential direction. The coil is wound around each teeth portion through the slot that is arranged on both sides of the teeth portion.

In this type of rotary electric machine, since the coil is at a high temperature at the time of use, it is desirable to efficiently cool the coil. As a method for efficiently cooling the coil of the rotary electric machine, a method is known in which a cooling liquid is caused to flow around the coil (for example, refer to Japanese Patent No. 7139969).

In the rotary electric machine described in Japanese Patent No. 7139969, the coil (rotary electric machine coil) that is wound around the teeth portion of the stator core is formed of a rectangular wire. Then, a cooling liquid flow groove (recess groove) having a substantially arc shape is formed on a side surface (side surface that faces in a direction orthogonal to an axis direction) of an insertion portion of the coil that is inserted through a slot. The cooling liquid that is introduced from a first end side in the axis direction of the stator core flows into the cooling liquid flow groove of the insertion portion of the coil, and the cooling liquid flows out to a second end side in the axis direction. At this time, the coil is efficiently cooled by the cooling liquid that flows through the cooling liquid flow groove.

### SUMMARY

The coil (rotary electric machine coil) used in the rotary electric machine described in Japanese Patent No. 7139969, since the cooling liquid flow groove having a substantially arc shape is formed on the side surface of the insertion portion, even when the side surface of the insertion portion of the coil may approach to (come into contact with) a side surface of another coil or an inner wall of the slot, it is possible to reliably ensure a flow path of the cooling liquid. However, it is necessary to process a groove (cooling liquid flow groove) having a recess shape on a surface (side surface) of the insertion portion of the coil. In this case, depending on the shape or the size of the groove having a recess shape to be processed, a surface strength of the coil may be degraded, or a flow resistance of the cooling liquid may be increased. Therefore, in this type of coil, it is desirable to prevent the increase of the flow resistance of the cooling liquid while preventing degradation of the surface strength.

An aspect of the present invention aims at providing a rotary electric machine coil and a rotary electric machine capable of maintaining the surface strength and reducing the flow resistance of a cooling liquid.

A rotary electric machine coil according to an aspect of the present invention is a rotary electric machine coil which is formed of a rectangular wire having a substantially rectangular shape in a cross section and in which a cooling liquid flow groove of a recess shape cross section having a substantially arc shape is formed on at least one side surface that faces in a direction which is orthogonal to an axis direction, wherein in the recess shape cross section, values a, b, x, R are set such that when a length of a virtual string that connects opening ends having a recess shape of the recess shape cross section to each other by a straight line is a, and the length of an arc along an inner surface of the recess shape is b, b/a becomes a first predetermined value T1 or less, and when the depth from the virtual string of the recess shape to the deepest portion of the arc is x, and the radius of the arc is R, the area of an inside of the recess shape represented by ((b−a) R+ax)/2 becomes a second predetermined value T2 or more.

In the rotary electric machine coil according to the aspect of the present invention, by setting a ratio b/a of the length a of the virtual string of the recess shape that forms the cooling liquid flow groove and the length b of the arc along the inner surface of the recess shape to the first predetermined value T1 or less, it is possible to prevent degradation of a surface at the time of processing of the cooling liquid flow groove from occurring. Further, by setting the lengths a, b described above, the depth x from the virtual string to the deepest portion of the arc of the recess shape, and the radius R of the arc of the recess shape such that the area of the inside of the recess shape becomes the second predetermined value T2 or more, it is possible to sufficiently reduce the flow resistance of the cooling liquid that flows through the cooling liquid flow groove.

The rectangular wire having the substantially rectangular shape in the cross section may be formed by coating an insulation film on an outer surface of a conductor wire, and the first predetermined value T1 may be an extension limit value of the insulation film.

In this case, by setting the ratio b/a to the first predetermined value T1 or less, when the cooling liquid flow groove is formed by press molding, it is possible to prevent the insulation film from peeling off from the conductor wire.

The second predetermined value T2 may be a value in which a pressure loss of a cooling liquid that flows through an inside of the recess shape becomes a reference value or less.

In this case, by setting the values a, b, x, R such that the area of the inside of the recess shape represented by ((b−a) R+ax)/2 becomes the second predetermined value T2 or more, it becomes possible to reduce the pressure loss of the cooling liquid that flows through the inside of the recess shape to be equal to or less than the reference value. Thereby, it becomes possible to sufficiently cool the rotary electric machine coil by the cooling liquid while reducing the loss of a power for supplying the cooling liquid.

Further, a rotary electric machine according to another aspect of the present invention is a rotary electric machine including: a stator having: a stator core which has a cylindrical shape and in which a plurality of teeth portions and a plurality of slots are provided alternately on an inner circumferential portion; and a plurality of rotary electric machine coils that are wound around each of the teeth portions through the slots; a rotor that is rotatably arranged on an inside in a radial direction of the stator; a first liquid room that is provided so as to face an end surface on a first side in an axis direction of the stator core; and a second liquid room that is provided so as to face an end surface on a second side in the axis direction of the stator core, wherein a cooling liquid that is introduced into the first liquid room flows into the second liquid room through the plurality of slots, the rotary electric machine coil is formed of a rectangular wire having a substantially rectangular shape in a cross section, in an insertion portion that is inserted through the slots of the rotary electric machine coil, a cooling liquid flow groove of a recess shape cross section having a substantially arc shape is formed on at least one side surface that faces in a direction which is orthogonal to an axis direction, and in the recess shape cross section, values a, b, x, R are set such that when a length of a virtual string that connects opening ends having a recess shape of the recess shape cross section to each other by a straight line is a, and the length of an arc along an inner surface of the recess shape is b, b/a becomes a first predetermined value T1 or less, and when the depth from the virtual string of the recess shape to the deepest portion of the arc is x, and the radius of the arc is R, an area of an inside of the recess shape represented by ((b−a) R+ax)/2 becomes a second predetermined value T2 or more.

In this case, the rectangular wire having the substantially rectangular shape in the cross section may be formed by coating an insulation film on an outer surface of a conductor wire, the first predetermined value T1 may be an extension limit value of the insulation film, and the second predetermined value T2 may be a value in which the pressure loss of a cooling liquid that flows through an inside of the recess shape becomes a reference value or less.

In the rotary electric machine coil according to the aspect of the present invention, the ratio b/a of the length a of the virtual string of the recess shape that forms the cooling liquid flow groove and the length b of the arc along the inner surface of the recess shape is set to the first predetermined value T1 or less, and the length a, b described above, the depth x from the virtual string to the deepest portion of the arc of the recess shape, and the radius R of the arc of the recess shape are set such that the area of the inside of the recess shape becomes the second predetermined value T2 or more. That is, the values a, b, x, R are set such that the area of the inside of the recess shape represented by ((b−a) R+ax)/2 becomes the second predetermined value T2 or more. Therefore, when the rotary electric machine coil according to the aspect of the present invention is employed, it is possible to maintain the surface strength and reduce the flow resistance of the cooling liquid.

Further, the rotary electric machine according to the aspect of the present invention that employs the rotary electric machine coil described above can also obtain effects similar to the effects described above.

### BRIEF DESCRIPTION OF THE DRAWINGS

FIG. 1 is a longitudinal cross-sectional view of a rotary electric machine of an embodiment.

FIG. 2 is a cross-sectional view along a II-II line of FIG. 1 of the rotary electric machine of the embodiment.

FIG. 3 is a cross-sectional view of a rotary electric machine coil of the embodiment.

FIG. 4 is a graph showing a desirable size relationship of portions of the rotary electric machine coil.

### DESCRIPTION OF EMBODIMENTS

Hereinafter, an embodiment of the present invention will be described with reference to the drawings.

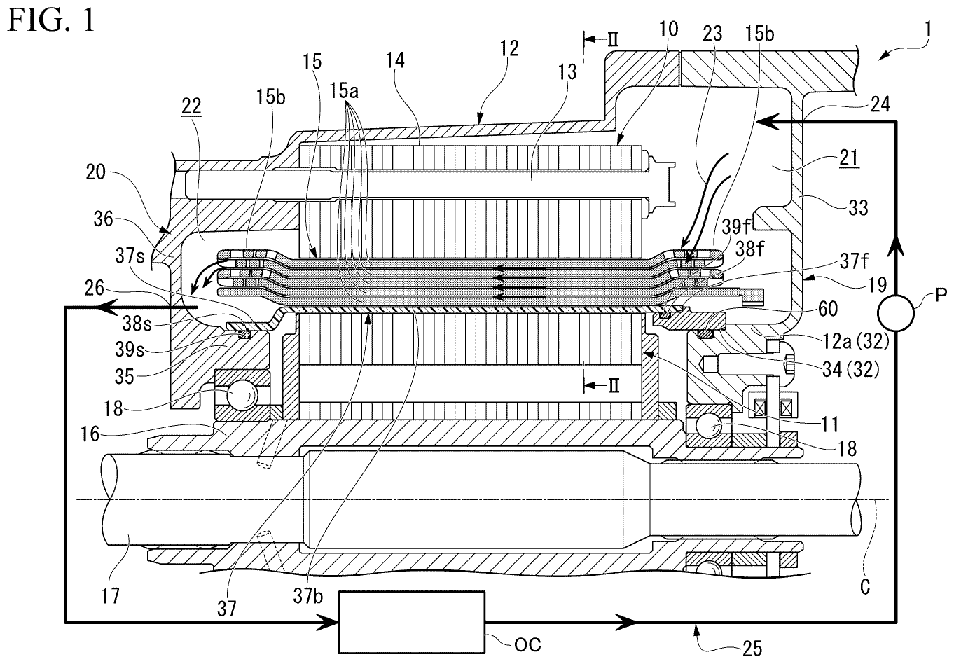

FIG. 1 is a longitudinal cross-sectional view of a rotary electric machine 1 of the present embodiment.

The rotary electric machine 1 of the present embodiment includes a stator 10 and a rotor 11. The stator 10 and the rotor 11 are accommodated in a rotary electric machine case 12. The stator 10 is fixed to an inside of the rotary electric machine case 12 by the fastening using a bolt 13 or the like. The stator 10 includes a stator core 14 having a cylindrical shape and a plurality of coils 15 that are wound around the stator core 14. The rotor 11 is rotatably arranged at an inside in a radial direction of the stator core 14 (stator 10).

The coil 15 constitutes a rotary electric machine coil in the present embodiment.

A permanent magnet (not shown) is attached to the vicinity of an outer circumferential surface of the rotor 11. Further, the rotor 11 is rotatably supported integrally by a rotation shaft 17 via a sleeve 16. The rotation shaft 17 becomes an output shaft when the rotary electric machine 1 is used as a motor, and the rotation shaft 17 becomes a power input shaft when the rotary electric machine 1 is used as an electricity generator. The rotation shaft 17 and the sleeve 16 are rotatably supported by the rotary electric machine case 12 via a bearing 18.

In the following description, a direction parallel to a rotation axis line C of the rotor 11 is referred to as an axis direction, a rotation direction of the rotor 11 is referred to as a circumferential direction, and a radial direction of the rotor 11 that is orthogonal to the axis direction and the circumferential direction is referred to as a radial direction.

A first side case 19 and a second side case 20 that have an annular shape are arranged on a first end side and a second end side in the axis direction of the stator core 14. Main parts of the first side case 19 and the second side case 20 are formed of the rotary electric machine case 12.

The first side case 19 covers, from the outside, an end surface on a first side in the axis direction of the stator core 14 and an exposure portion of the coil 15 that protrudes from the end surface. The first side case 19 forms a first liquid room 21 having an annular shape together with the end surface on the first side in the axis direction of the stator core 14. An introduction port 24 for introducing a cooling liquid 23 into the first liquid room 21 is formed on the first side case 19. The introduction port 24 is connected to a circulation circuit 25 of the cooling liquid 23. The cooling liquid 23 that is introduced into the first liquid room 21 cools the exposure portion of the coil 15 that protrudes from the end surface on the first side of the stator core 14, then passes through the inside of the stator core 14, and flows into a second end side in the axis direction of the stator core 14.

The second side case 20 covers, from the outside, an end surface on a second side in the axis direction of the stator core 14 and an exposure portion of the coil 15 that protrudes from the end surface. The second side case 20 forms a second liquid room 22 having an annular shape together with the end surface on the second side in the axis direction of the stator core 14. The cooling liquid 23 that is introduced into the first liquid room 21 flows into the second liquid room 22 through the inside of the stator core 14. The cooling liquid 23 that is introduced into the second liquid room 22 cools the exposure portion of the coil 15 that protrudes from the end surface on the second side of the stator core 14. A discharge port 26 for discharging the cooling liquid 23 in the second liquid room 22 to the outside is formed on the second side case 20. The discharge port 26 is connected to the circulation circuit 25 of the cooling liquid 23. The cooling liquid 23 that has cooled the coil 15 in the second liquid room 22 is caused to return to the circulation circuit 25 from the discharge port 26.

In the circulation circuit 25, a supply pump P is connected to a middle of the circuit. A heat exchanger OC that cools the cooling liquid 23 by a heat exchange with outside air is connected to an upstream side of the supply pump P in the circulation circuit 25. A downstream side of the supply pump P is connected to the introduction port 24. Further, an upstream side of the heat exchanger OC in the circulation circuit 25 is connected to the discharge port 26.

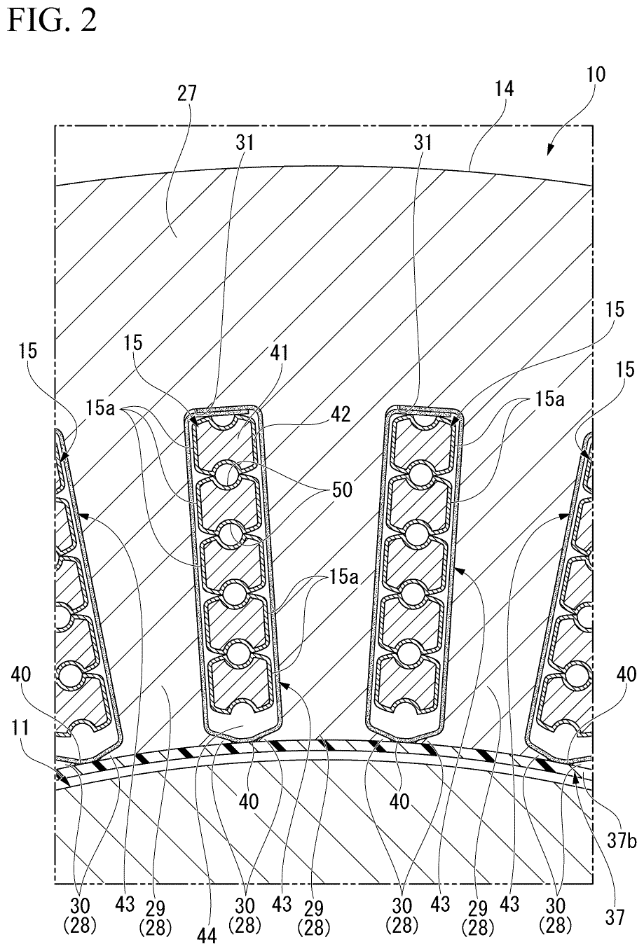

FIG. 2 is a cross-sectional view along a II-II line of FIG. 1 of the rotary electric machine 1.

The stator core 14 is formed, for example, by laminating a plurality of electromagnetic steel plates in the axis direction. In the stator core 14, as shown in FIG. 2, a back yoke 27 having a cylindrical shape and a plurality of teeth portions 28 that protrude inward in the radial direction from an inner circumferential portion of the back yoke 27 are integrally molded. The back yoke 27 is formed such that a cylinder center is matched with the rotation axis line C.

The teeth portions 28 are arranged to be spaced apart from each other in the circumferential direction. The teeth portion 28 is formed in a T shape when seen from the axis direction. That is, in the teeth portion 28, a teeth main body 29 that protrudes inward in the radial direction from the inner circumferential portion of the back yoke 27 and a flange portion 30 that projects to both sides in the circumferential direction from an inner end in the radial direction in the teeth main body 29 are integrally molded.

A slot 31 in which an inner side in the radial direction is opened is formed between the teeth portions 28 that are adjacent to each other in the circumferential direction. The slot 31 is formed to be surrounded by side walls that face each other of the teeth portions 28 that are adjacent to each other and an inner circumferential wall of the back yoke 27. The side wall of each teeth portion 28 is formed of a side portion of the teeth main body 29 and a side section of the flange portion 30. A portion of the slot 31 that is formed of the side portions of the right and left teeth main bodies 29 has a substantially constant width. Further, a width of a portion of the slot 31 that is formed of the side sections of the right and left flange portions 30 is narrower than a width of the portion that is formed of the side portions of the right and left teeth main bodies 29.

An opening 40 on the inside in the radial direction of each slot 31 is formed to be sandwiched by front end sections of the right and left (both sides in the circumferential direction) flange portions 30 of the slot 31. Further, each slot 31 penetrates through the stator core 14 in the axis direction.

In the coil 15, for example, three phases which are a U-phase, a V-phase, and a W-phase are provided. The coil 15 is constituted, for example, by connecting a plurality of segment coils to each other. In the coil 15, an outer surface of a conductor wire 41 made of a metal is covered by an insulation film 42. Further, the coil 15 is constituted of a rectangular wire. That is, a shape of a cross section that is orthogonal to the axis direction of the coil 15 is formed in a substantially rectangular shape.

Each coil 15 is inserted along the axis direction through the slot 31 of the stator core 14 and is wound around a corresponding teeth portion 28 in that state.

Hereinafter, a portion of the coil 15 that is inserted through the slot 31 is referred to as an “insertion portion 15a”, and a portion that is exposed to the outside of the slot 31 and is drawn in a direction of another slot 31 is referred to as a “drawn portion 15b”.

As shown in FIG. 2, a plurality of insertion portions 15a of the coil 15 are inserted through each slot 31 in a step manner. The plurality of insertion portions 15a that are inserted through the same slot 31 are aligned in a line along the radial direction. In the present embodiment, for example, five insertion portions 15a are inserted through the same slot 31. However, the number of the insertion portions 15a that are inserted through the same slot 31 is not limited to this and can be arbitrarily set.

In a state where the plurality of insertion portions 15a that are inserted and arranged in each slot 31 are bundled so as to be aligned in a line in parallel with each other, and the periphery of the plurality of insertion portions 15a is covered by a sheet of a foamable insulation member 43. For example, it is possible to employ a foamable insulation member 43 in which a foamable adhesion bond is arranged (applied) on a surface (a surface that faces outward in a state of covering the insertion portion 15a) of a base material sheet having an electrical insulation property, and a non-foamable adhesion bond is arranged (applied) on a rear surface of the base material sheet. The foamable insulation member 43 is inserted and arranged in a corresponding slot 31 together with the plurality of insertion portions 15a in a state of covering the periphery of the plurality of insertion portions 15a. Then, by performing a heating treatment or the like, the foamable insulation member 43 foams in the corresponding slot 31. As a result, part of the outer surface of the foamable insulation member 43 is bonded to the inner wall of the slot 31.

Even after the insertion portion 15a of the coil 15 and the foamable insulation member 43 are arranged in the slot 31 as described above, a gap for causing a first end side in the axis direction of the stator core 14 to communicate with a second end side is ensured at the inside of the slot 31. The gap constitutes a cooling liquid passage 44 for causing the cooling liquid that is introduced into the first liquid room 21 to flow to the second liquid room 22 side. The gap that constitutes the cooling liquid passage 44 is, specifically, a gap between an inner surface of the foamable insulation member 43 and the insertion portion 15a, a gap between the insertion portions 15a that are adjacent to each other, a gap between an outer surface of the foamable insulation member 43 and an inner wall of the slot 31, or the like. The cooling liquid 23 that flows through the cooling liquid passage 44 in the slot 31 absorbs heat of the insertion portion 15a of the coil 15.

A recess groove 50 that extends along the axis direction of the stator core 14 is formed on a side surface that faces outward in the radial direction and a side surface that faces inward in the radial direction of each insertion portion 15a which is arranged in the slot 31. The recess groove 50 is formed to be recessed in a substantially arc shape toward a middle region in a width direction of the insertion portion 15a.

When the plurality of insertion portions 15a are arranged together with the foamable insulation member 43 in the slot 31, the recess groove 50 forms a gap (communication gap) that extends substantially along the axis direction between side surfaces that face each other of the insertion portions 15a that are adjacent to each other in the radial direction and between a side surface of the insertion portion 15a and an inner surface of the foamable insulation member 43.

In the present embodiment, the recess groove 50 that is formed on the side surface of the coil 15 constitutes a cooling liquid flow groove. Further, in the present embodiment, the recess groove 50 is formed so as to continue to the recess groove 50 of the insertion portion 15a also on the drawn portion 15b of the coil 15. Details of the recess groove 50 will be described later.

Further, as shown in FIG. 1, the first side case 19 on a first end side in the axis direction of the stator core 14 includes a first inner circumferential wall 32 that faces the first liquid room 21. The first inner circumferential wall 32 protrudes in a cylindrical shape from an inner end portion in the radial direction of an end side wall 33 of the first side case 19 located at an outer end in the axis direction of the first liquid room 21 toward an end surface on a first side in the axis direction of the rotor 11. In the case of the present embodiment, the first inner circumferential wall 32 is constituted of a circumferential wall main body portion 12a that is formed integrally with the rotary electric machine case 12 (end side wall 33) and a cylindrical member 34 as a separate body that is attached to an outer circumferential surface on an extension end side of the circumferential wall main body portion 12a. A space between the circumferential wall main body portion 12a and the cylindrical member 34 is sealed by a seal member 60 having an annular shape.

However, the entire first inner circumferential wall 32 may be formed integrally with the rotary electric machine case 12 (end side wall 33).

Further, the second side case 20 on a second end side in the axis direction of the stator core 14 includes a second inner circumferential wall 35 that faces the second liquid room 22. The second inner circumferential wall 35 protrudes in a cylindrical shape from an inner end portion in the radial direction of an end side wall 36 of the second side case 20 located at an outer end in the axis direction of the second liquid room 22 toward an end surface on a second side in the axis direction of the rotor 11. In the case of the present embodiment, the second inner circumferential wall 35 is formed integrally with the rotary electric machine case 12 (end side wall 36).

However, the second inner circumferential wall 35 may be constituted of a circumferential wall main body portion that is integral with the rotary electric machine case 12 (end side wall 36) similarly to the first inner circumferential wall 32 and a cylindrical member as a separate body.

An annular partition wall 37 which is a cover member having a cylindrical shape is provided on an outer circumferential surface of the first inner circumferential wall 32 of the first side case 19 and an outer circumferential surface of the second inner circumferential wall 35 of the second side case 20. The annular partition wall 37 is formed of, for example, a resin material. However, the annular partition wall 37 can be also formed of another material such as a metal material. The annular partition wall 37 has a first end portion 37f that faces the inside of the first liquid room 21, a second end portion 37s that faces the inside of the second liquid room 22, and a partition wall main body portion 37b that is located between the first end portion 37f and the second end portion 37s and faces an inner circumferential surface of the stator core 14. The first end portion 37f is formed to have the same inner diameter as the partition wall main body portion 37b. The diameter of a middle portion in an extension direction of the second end portion 37s is reduced in a step manner with respect to the partition wall main body portion 37b.

An inner circumferential surface of the first end portion 37f is slidably fitted to an outer circumferential surface of the cylindrical member 34 of the first inner circumferential wall 32. An annular groove 38f is formed on the outer circumferential surface of the cylindrical member 34, and a seal member 39f having an annular shape such as an O-ring is attached to the annular groove 38f. A space between the cylindrical member 34 (first inner circumferential wall 32) and the first end portion 37f (annular partition wall 37) is sealed in a liquid-tight manner by the seal member 39f.

In the present embodiment, the first end portion 37f constitutes, at the inside of the first liquid room 21, a guide member that guides the cooling liquid in the first liquid room 21 to the slot 31 on a first end side in the axis direction of the stator core 14.

An inner circumferential surface of a reduced diameter section of the second end portion 37s is slidably fitted to an outer circumferential surface of the second inner circumferential wall 35. An annular groove 38s is formed on the outer circumferential surface of the second inner circumferential wall 35, and a seal member 39s having an annular shape such as an O-ring is attached to the annular groove 38s. A space between the second inner circumferential wall 35 and the second end portion 37s (annular partition wall 37) is sealed in a liquid-tight manner by the seal member 39f.

In the annular partition wall 37, as described above, the first end portion 37f is fitted in a liquid-tight manner to the first inner circumferential wall 32 of the first side case 19, and the second end portion 37s is fitted in a liquid-tight manner to the second inner circumferential wall 35 of the second side case 20. The annular partition wall 37 separates an inner region in the radial direction of the stator core 14 attached to the inside of the rotary electric machine case 12 from the outer circumferential surface of the rotor 11. Therefore, even if the cooling liquid 23 leaks out from the slot 31 of the stator core 14 to the inner region in the radial direction, it is possible to prevent the cooling liquid 23 from flowing into the outer circumferential surface side of the rotor 11.

Further, an expansion portion that expands further outward in the radial direction than an outer circumferential surface of the partition wall main body portion 37b is provided on an outer circumferential surface of the first end portion 37f of the annular partition wall 37. An end section of the expansion portion on the stator core 14 side stands outward in the radial direction in a step manner with respect to the outer circumferential surface of the partition wall main body portion 37b. This standing end surface is in contact with an end surface on the first end side in the axis direction of the stator core 14.

As shown in FIG. 2, the outer circumferential surface of the partition wall main body portion 37b of the annular partition wall 37 is maintained in a state of being in contact with the inner circumferential surface of the stator core 14. Further, the inner circumferential surface of the partition wall main body portion 37b of the annular partition wall 37 faces the outer circumferential surface of the rotor 11 with a small gap so as to be non-contact with the outer circumferential surface of the rotor 11.

The foamable adhesion bond on the outer surface side foams by heating or the like, and thereby, the foamable insulation member 43 that is accommodated and arranged in each slot 31 of the stator core 14 together with the plurality of insertion portions 15a of the coil 15 enters the inside of the opening 40 at the inside in the radial direction of the slot 31. The foamable adhesion bond that has entered the inside of the opening 40 is bonded to an outer circumferential surface of the annular partition wall 37 that is arranged at the outside of the opening 40. As a result, the circumferential wall main body portion 12a of the annular partition wall 37 is bonded and fixed to the foamable insulation member 43 at the inside of the plurality of slots 31 through the opening 40 of the slot 31.

In the rotary electric machine 1 having the configuration described above, when a current continuously flows through the coil 15 at the time of operation, the coil 15 generates heat and becomes a high temperature.

At this time, the cooling liquid 23 is introduced into the first liquid room 21 of the rotary electric machine 1 through the introduction port 24 from the circulation circuit 25. The cooling liquid 23 that is introduced into the first liquid room 21 flows in the first liquid room 21 and thereby cools a region (the drawn portion 15b) on a first end portion side of the coil 15 that is exposed to the outside from the first end side in the axis direction of the stator core 14. Further, the cooling liquid 23 flows through the plurality of slots 31 (cooling liquid passage 44 in the slots 31) of the stator core 14 from a first end side in the axis direction toward a second end side and flows into the second liquid room 22. The cooling liquid that flows through the inside of the slot 31 cools the insertion portion 15a of the coil 15 that is inserted through the inside of the slot 31. Further, the cooling liquid 23 that flows into the second liquid room 22 cools a region on a second end portion side of the coil 15 that is exposed to the outside from the second end side in the axis direction of the stator core 14 and is then caused to return to the circulation circuit 25 through the discharge port 26.

In the rotary electric machine 1, the stator 10 is constantly submerged in the cooling liquid 23 in the rotary electric machine case 12 as described above, and in that state, the cooling liquid 23 in the rotary electric machine case 12 is replaced through the circulation circuit 25. Therefore, the coil 15 of the stator 10 is efficiently cooled by the cooling liquid 23.

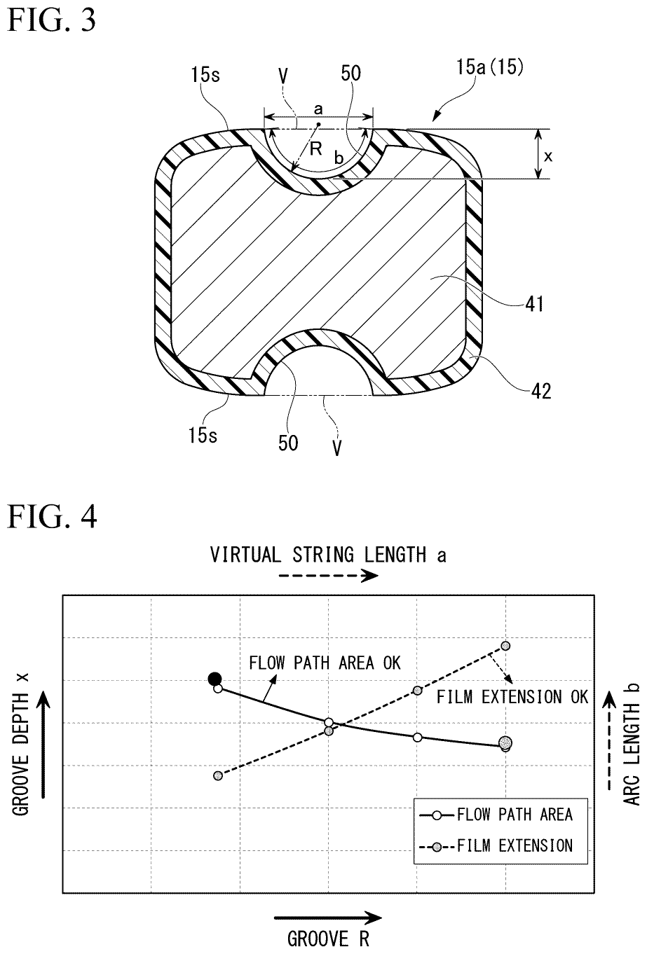

Next, with reference to FIG. 3 and FIG. 4, the details of the recess groove 50 (cooling liquid flow passage) that is formed on a side surface 15s (a side surface that faces in a direction which is orthogonal to the axis direction) of each coil 15 are described.

FIG. 3 is an enlarged view showing a cross section of the coil 15. FIG. 4 is a graph showing a desirable size relationship of portions of the coil 15.

As shown in FIG. 3, the coil 15 is formed of a rectangular wire having a substantially rectangular shape in a cross section.

As described above, in the coil 15 (rectangular wire), the outer surface of the conductor wire 41 is uniformly coated by the insulation film 42. The recess groove 50 is formed on at least one side surface 15s that faces in a direction which is orthogonal to the axis direction of the coil 15. In the present embodiment, the recess grooves 50 that are similar to each other are formed on two side surfaces 15s that face in a direction opposite to each other of the coil 15. In the recess groove 50, a recess shape cross section having a substantially arc shape extends along the axis direction of the coil 15.

In the recess shape cross section of the recess groove 50, the sizes of the portions are set such that the following Expressions (1), (2) are satisfied at the same time.

b/a≤T1 (1)

((b−a)R+ax)/2≥T2 (2)
a: a length of a virtual string v that connects opening ends of a recess shape having the recess shape cross section to each other by a straight line
b: a length of an arc along an inner surface of the recess shape
x: a depth from the virtual string v of the recess shape to the deepest portion of the arc
R: a radius of the arc
T1: a first predetermined value
T2: a second predetermined value

That is, in the recess shape cross section of the recess groove 50, the sizes a, b, x, R are set such that the ratio b/a of the length a of the virtual string v and the length b of the arc becomes the first predetermined value T1 or less, and the area of the inside of the recess shape represented by ((b−a) R+ax)/2 becomes the second predetermined value T2 or more.

The first predetermined value T1 is an extension limit value of the insulation film 42 that coats the outer surface of the conductor wire 41 of the coil 15. That is, the first predetermined value T1 is set to a value in which when the recess groove 50 is formed by press molding, if the ratio b/a becomes larger than the first predetermined value T1, the insulation film 42 reaches an extension limit and is broken.

Further, the second predetermined value T2 is a value in which the pressure loss of the cooling liquid 23 that flows through the inside of the recess shape of the recess groove 50 becomes a reference value or less. The reference value of the pressure loss in this case is, for example, a value at which the loss of a power for supplying the cooling liquid 23 becomes an allowable value or more if a value becomes larger than the reference value, or a value at which a cooling failure of the coil 15 occurs if a value becomes larger than the reference value. The reference value can be appropriately set in accordance with the specification of the rotary electric machine 1.

FIG. 4 is a graph showing a test result in which the lengths a, b that satisfy Expression (1) and the depth x and the radius R that satisfy Expression (2) are plotted. In FIG. 4, in a region where the values a, b are located below a dotted line, the extension limit value of the insulation film is not reached. Further, in a region where the values x, R are located above a solid line, it is possible to ensure a sufficient flow path area, and the pressure loss is equal to or less than the reference value.

As described above, in the coil 15 of the rotary electric machine 1 of the present embodiment, the ratio b/a of the length a of the virtual string of the recess shape that forms the recess groove 50 (cooling liquid flow groove) and the length b of the arc along the inner surface of the recess shape is set so as to become the first predetermined value T1 or less. Therefore, it is possible to prevent degradation of the surface at the time of processing of the recess groove 50 from occurring. Further, in the coil 15 of the rotary electric machine 1 of the present embodiment, the lengths a, b described above, the depth x from the virtual string v to the deepest portion of the arc of the recess shape, and the radius R of the arc of the recess shape are set such that the area of the inside of the recess shape becomes the second predetermined value T2 or more. Therefore, it is possible to sufficiently reduce the flow resistance of the cooling liquid 23 that flows through the recess groove 50.

Accordingly, when the coil 15 of the present embodiment is employed, it is possible to maintain the surface strength of the coil 15 and reduce the flow resistance of the cooling liquid 23.

Further, in the coil 15 of the rotary electric machine 1 of the present embodiment, the value of the first predetermined value T1 is set to a value that matches the extension limit value of the insulation film 42 that coats the outer surface of the conductor wire 41. Therefore, when the present configuration is employed, it is possible to prevent the insulation film 42 from peeling off from the conductor wire 41 when the recess groove 50 (cooling liquid flow groove) is formed on the side surface 15s of the coil 15 by press molding.

Further, in the coil 15 of the rotary electric machine 1 of the present embodiment, the value of the second predetermined value T2 is set to a value in which the pressure loss of the cooling liquid 23 that flows through the inside of the recess shape of the recess groove 50 becomes the reference value or less. Therefore, when the present configuration is employed, the pressure loss of the cooling liquid 23 that flows through the inside of the recess shape of the recess groove 50 is reduced to be equal to or less than the reference value, and it is possible to sufficiently cool the coil 15 by the cooling liquid while reducing the loss of the power for supplying the cooling liquid 23.

Further, in the rotary electric machine 1 of the present embodiment, the recess groove 50 that is set to the size described above is formed on the side surface 15s of the insertion portion 15a of the coil 15 that is inserted through the slot 31 of the stator core 14. Therefore, it is possible to cause the cooling liquid 23 of a necessary and sufficient flow rate to flow between the plurality of insertion portions 15a that are accommodated and arranged in a state of being close to each other in the slot 31 and between the inner surface of the foamable insulation member 43 and the insertion portion 15a while preventing the coil 15 from peeling off at the time of manufacturing.

The present invention is not limited to the embodiment described above, and various design changes can be made without departing from the scope of the invention. For example, in the embodiment described above, the recess groove 50 is formed on two side surfaces 15s that face in a direction opposite to each other of the insertion portion 15a of the coil 15; however, the recess groove 50 may be formed on at least one surface among side surfaces that face in a direction which is orthogonal to the axis direction of the coil 15. The recess groove 50 may be formed on three or more surfaces among four surfaces around the coil 15.

Further, in the embodiment described above, the coil 15 (rotary electric machine coil) having the recess groove 50 described above is used in a stator 10 portion of the rotary electric machine 1; however, the coil 15 can be also applied to a portion other than the stator 10. For example, in a rotary electric machine in which a coil winding portion is provided on a rotor portion, the coil 15 can be also applied to the rotor portion.

What is claimed is:

1. A rotary electric machine coil which is formed of a rectangular wire having a substantially rectangular shape in a cross section and in which a cooling liquid flow groove of a recess shape cross section having a substantially arc shape is formed on at least one side surface that faces in a direction which is orthogonal to an axis direction,
wherein in the recess shape cross section, values a, b, x, R are set such that when a length of a virtual string that connects opening ends having a recess shape of the recess shape cross section to each other by a straight line is a, and a length of an arc along an inner surface of the recess shape is b, b/a becomes a first predetermined value T1 or less, and
when a depth from the virtual string of the recess shape to the deepest portion of the arc is x, and a radius of the arc is R, an area of an inside of the recess shape represented by ((b−a) R+ax)/2 becomes a second predetermined value T2 or more.

2. The rotary electric machine coil according to claim 1,
wherein the rectangular wire having the substantially rectangular shape in the cross section is formed by coating an insulation film on an outer surface of a conductor wire, and
the first predetermined value T1 is an extension limit value of the insulation film.

3. The rotary electric machine coil according to claim 1,
wherein the second predetermined value T2 is a value in which a pressure loss of a cooling liquid that flows through an inside of the recess shape becomes a reference value or less.

4. The rotary electric machine coil according to claim 2,
wherein the second predetermined value T2 is a value in which a pressure loss of a cooling liquid that flows through an inside of the recess shape becomes a reference value or less.

5. A rotary electric machine comprising:
a stator having: a stator core which has a cylindrical shape and in which a plurality of teeth portions and a plurality of slots are provided alternately on an inner circumferential portion; and a plurality of rotary electric machine coils that are wound around each of the teeth portions through the slots;
a rotor that is rotatably arranged on an inside in a radial direction of the stator;
a first liquid room that is provided so as to face an end surface on a first side in an axis direction of the stator core; and
a second liquid room that is provided so as to face an end surface on a second side in the axis direction of the stator core,
wherein a cooling liquid that is introduced into the first liquid room flows into the second liquid room through the plurality of slots,
the rotary electric machine coil is formed of a rectangular wire having a substantially rectangular shape in a cross section,
in an insertion portion that is inserted through the slots of the rotary electric machine coil, a cooling liquid flow groove of a recess shape cross section having a substantially arc shape is formed on at least one side surface that faces in a direction which is orthogonal to an axis direction, and
in the recess shape cross section, values a, b, x, R are set such that
when a length of a virtual string that connects opening ends having a recess shape of the recess shape cross section to each other by a straight line is a, and a length of an arc along an inner surface of the recess shape is b, b/a becomes a first predetermined value T1 or less, and
when a depth from the virtual string of the recess shape to the deepest portion of the arc is x, and a radius of the arc is R, an area of an inside of the recess shape represented by ((b−a) R+ax)/2 becomes a second predetermined value T2 or more.

6. The rotary electric machine according to claim 5,
wherein the rectangular wire having the substantially rectangular shape in the cross section is formed by coating an insulation film on an outer surface of a conductor wire,
the first predetermined value T1 is an extension limit value of the insulation film, and
the second predetermined value T2 is a value in which a pressure loss of a cooling liquid that flows through an inside of the recess shape becomes a reference value or less.
